(19) United States
(12) Patent Application Publication
(10) Pub. No.: US 2025/0188696 A1
(43) Pub. Date: Jun. 12, 2025

(54) WATERPROOF PLATE FOR BOUNDARY STONE

(71) Applicant: MORRIS&CO CO., LTD., Chungcheongbuk-do (KR)

(72) Inventor: BORA JUNG, Seoul (KR)

(21) Appl. No.: 18/922,653

(22) Filed: Oct. 22, 2024

(30) Foreign Application Priority Data
Dec. 12, 2023 (KR) 10-2023-0179715

(51) Int. Cl. E02B 3/10; E06B 9/00

(52) U.S. Cl. CPC E02B 3/106; E06B 9/00; E06B 2009/007

(57) ABSTRACT

Proposed is a waterproof plate for a boundary stone, the waterproof plate being connected to and installed at a left or right end of a waterproof wall body formed by connecting a plurality of basic waterproof plates, each of which includes a bottom plate placed on a ground surface and a wall plate extending upward from a rear end of the bottom plate. The waterproof plate includes a boundary bottom plate placed on the ground surface and connected to the bottom plate of the basic waterproof plate, a boundary wall plate extending upward from a rear end of the boundary bottom plate and connected to the wall plate of the basic waterproof plate, and a boundary blocking plate coupled to the boundary wall plate and placed on a boundary ground surface formed at a side end of the ground surface to be stepped higher upward than the ground surface.

### CROSS REFERENCE TO RELATED APPLICATION

The present application claims priority to Korean Patent Application No. 10-2023-0179715, filed Dec. 12, 2023, the entire contents of which is incorporated herein for all purposes by this reference.

### BACKGROUND OF THE INVENTION

### 1. Field of the Invention

The present disclosure relates generally to a waterproof plate for a boundary stone and, more particularly, to a waterproof plate for a boundary stone that can be easily applied to stepped areas caused by boundary stones or the like.

### 2. Description of Related Art

In recent years, the frequency of localized torrential rain occurrences has increased as a result of climate change. Additionally, an increase in impervious surfaces, such as roads and pavement, associated with urbanization has contributed to the increased risk of flood damage. In particular, flooding in low-lying areas, underground parking lots, subways, underground shopping malls, and underground buildings has led to large losses in property and lives.

Flood damage caused by such localized torrential rain is difficult to forecast and can increase rapidly due to a short flood arrival time.

As a solution to prevent such damage, there is proposed a “MOVABLE STREAMLINED FLOOD PROTECTION PLATE” as disclosed in Korean Patent No. 10-1898870. The movable streamlined flood protection plate according to the related art includes a bottom plate that is formed flat to be placed on the ground, has a plurality of wrinkle portions protruding upward at predetermined intervals, and has at least one inner guide between the plurality of wrinkle portions to guide the flow of water; and a wall plate that is connected vertically upward from the bottom plate to form a wall and has an arch-shaped portion protruding from the wall in a round shape and disposed inclinedly toward the bottom plate. The arch-shaped portion is disposed vertically along the left and right centers of the wall plate, and has a shape whose protruding size gradually increases from a lower end to an upper end of the wall plate. Each wrinkle portions has a cone shape whose protruding size gradually increases from the bottom plate toward the wall plate. An end of each of wrinkle portion is connected to each side of a lower end of the arch-shaped portion. The inner guide is provided between the plurality of wrinkle portions in a direction parallel to the plurality of wrinkle portions. The inner guide includes a plurality of front portions that protrude in a straight line in parallel with the plurality of wrinkle portions at a point where the plurality of wrinkle portions begin; and a plurality of rear portions that protrude from the front portions to extend in a V shape and are connected to the plurality of wrinkle portions. With this configuration, when water rises, the water pressure is directed downward while the flow of water is directed quickly to the left and right, thereby providing stable support. Additionally, water is directed to flow quickly to the left and right, and when a plurality of protection plates are connected to each other, they form an overall wave-shaped arch, thereby increasing the ability to withstand the water pressure and dispersing the water pressure. Furthermore, water is directed to flow quickly and stably, thereby directing the overall water pressure to the deepest part of the plate and bringing stability to the center of gravity of the plate.

However, the above conventional technology is problematic in that it cannot be applied when a stepped area exists on the side of a road.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-1898870
(Patent document 2) Korean Patent Application Publication No. 10-2019-0071311

### SUMMARY OF THE INVENTION

Accordingly, the present disclosure has been made keeping in mind the above problems occurring in the related art, and one objective of the present disclosure is to provide a waterproof plate for a boundary stone that can be easily applied even when there is a stepped area on the side of a road caused by boundary stones or the like.

Another objective of the present disclosure is to provide a waterproof plate for a boundary stone that can be easily applied even when a stepped area on the side of a road caused by boundary stones or the like is not horizontal but is inclined in the front-rear direction or the left-right direction.

In order to achieve the above objectives, according to one aspect of the present disclosure, there is provided a waterproof plate for a boundary stone, the waterproof plate being connected to and installed at a left or right end of a waterproof wall body that is formed by connecting a plurality of basic waterproof plates, each of which includes a bottom plate that is placed on a ground surface and a wall plate that extends upward from a rear end of the bottom plate, and the waterproof plate including: a boundary bottom plate that is placed on the ground surface and is connected to the bottom plate of the basic waterproof plate; a boundary wall plate that extends upward from a rear end of the boundary bottom plate and is connected to the wall plate of the basic waterproof plate; and a boundary blocking plate that is coupled to the boundary wall plate and is placed on a boundary ground surface that is formed at a side end of the ground surface to be stepped higher upward than the ground surface. The waterproof plate may completely block the entry of water despite the boundary ground surface being formed to be highly stepped upward at the side end of the ground surface.

The basic waterproof plate may include: a pair of bottom protrusions that protrude upward from the bottom plate and have a height that gradually increases rearward; and a pair of parallel wall protrusions that protrude forward from the wall plate. The wall protrusions may be connected to the bottom protrusions.

The basic waterproof plate may further include: an upper protrusion that protrudes forward from the wall plate and connects upper ends of the pair of wall protrusions in a left-right direction; and a handle hole that is formed therethrough below the upper protrusion.

The basic waterproof plate may further include a lower protrusion that protrudes forward from the wall plate and connects lower portions of the pair of wall protrusions in a left-right direction.

The basic waterproof plate may further include a gap blocking plate that is coupled to a front end of the bottom plate. The gap blocking plate may block a gap that is generated between the front end of the bottom plate and the ground surface due to inclination of the ground surface.

The waterproof plate may further include an angle height adjustment part that couples the boundary blocking plate and the boundary wall plate to each other. The angle height adjustment part may include: an arc-shaped groove that is formed at an end of the boundary wall plate; and a spherical protrusion that is formed at an end of the boundary blocking plate. The spherical protrusion may be installed by sliding the spherical protrusion into the arc-shaped groove in a from-upper-to-lower direction, the protrusion may be adjusted in vertical installation height thereof depending on a degree of insertion of the boundary blocking plate and is prevented from deviating in a lateral direction, and the protrusion may be rotatable within the groove to effectively respond to changes in height and width of the boundary ground surface.

The waterproof plate may further include a boundary side plate that connects an end of the boundary bottom plate and an end of the boundary wall plate to each other. The boundary side plate may be formed in a shape with a front upper portion being cut and removed so that water flowing toward an outside and an inside of the boundary side plate flows effectively, thereby quickly eliminating a difference in water pressure.

A part of a central portion of the arc-shaped groove may be open between the boundary side plate and the boundary wall plate.

The waterproof plate may further include a lower blocking plate that is coupled to a lower end of the boundary blocking plate. The lower blocking plate may be installed inclinedly forward and downward.

The lower blocking plate may be integrally coupled to the lower end of the boundary blocking plate with an adhesive, or may be detachably attached to the lower end of the boundary blocking plate in a fitting manner.

According to the present disclosure, the waterproof plate for the boundary stone according to the present disclosure can be easily applied even when there is a stepped area on the side of a road caused by boundary stones or the like.

Additionally, the waterproof plate for the boundary stone according to the present disclosure can be easily applied even when a stepped area on the side of a road caused by boundary stones or the like is not horizontal but is inclined in the front-rear direction or the left-right direction.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates a perspective view of waterproof plates for boundary stones and basic waterproof plates according to an embodiment of the present disclosure installed at the entrance of an underground parking lot;

FIG. 2A illustrates a perspective view of a basic waterproof plate according to the present disclosure;

FIGS. 2B and 2C illustrate a perspective view and an enlarged view of a gap blocking plate provided at a front end of the basic waterproof plate according to the present disclosure;

FIG. 3 illustrates a perspective view of basic waterproof plates according to the present disclosure that are connected to each other and installed;

FIG. 4 illustrates a perspective view of a waterproof plate for a boundary stone according to the present disclosure;

FIG. 5 illustrates a plan view of the waterproof plate for the boundary stone according to the present disclosure;

FIG. 6 illustrates a perspective view of a boundary blocking plate of the waterproof plate for the boundary stone according to the present disclosure that is coupled to a boundary wall plate; and

FIG. 7 illustrates a perspective view and an enlarged sectional view of a lower blocking plate installed by coupling to a lower end of the boundary blocking plate according to the present disclosure.

### DETAILED DESCRIPTION OF THE INVENTION

Reference will now be made in greater detail to some exemplary embodiments of the present disclosure with reference to the accompanying drawings. As for reference numerals associated with parts in the drawings, the same reference numerals will refer to the same or like elements throughout the different drawings. Further, in describing embodiments of the present disclosure, a detailed description of known functions and configurations incorporated herein will be omitted when it is determined that the description may make the subject matter of the present disclosure rather unclear.

Further, in describing elements of the present disclosure, the terms, such as first, second, A, B, (a), or (b) may be used. Each of these terms is not used to define essence, order, sequence, or number of an element, but is used merely to distinguish the corresponding element from another element. When it is mentioned that an element is “connected”, “coupled”, or “linked” to another element, it should be interpreted that another element may be “interposed” between the elements or the elements may be “connected”, “coupled”, or “linked” to each other via another element as well as that one element is directly connected or coupled to another element.

Hereinafter, a waterproof plate for a boundary stone according to an embodiment of the present disclosure will be described with reference to the drawings.

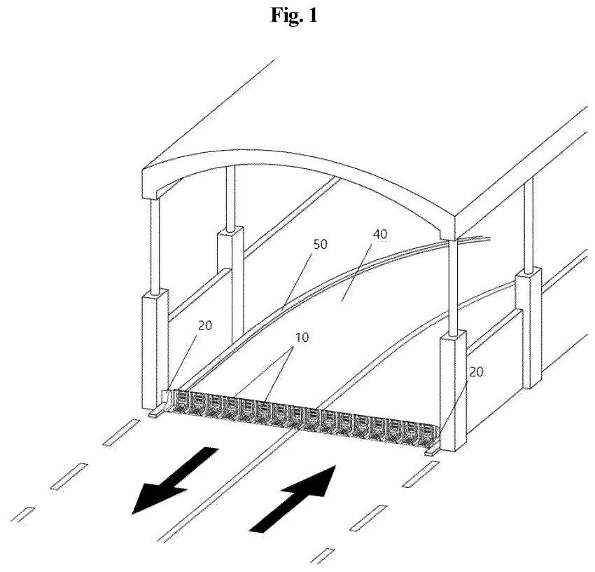

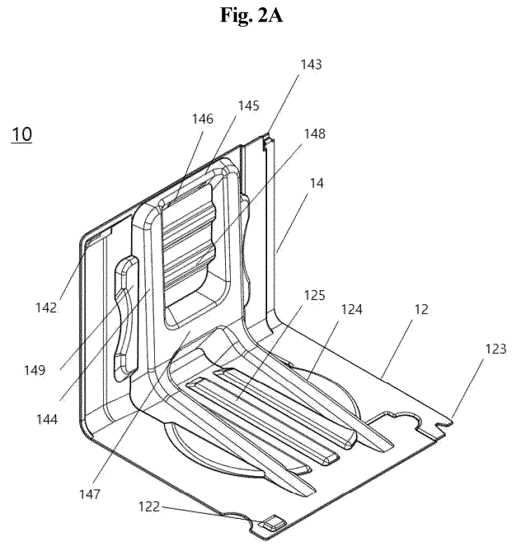

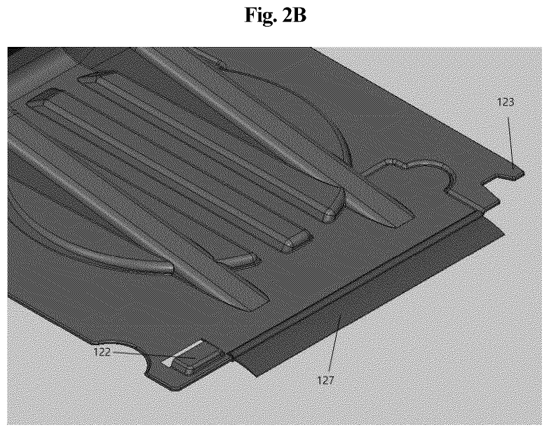

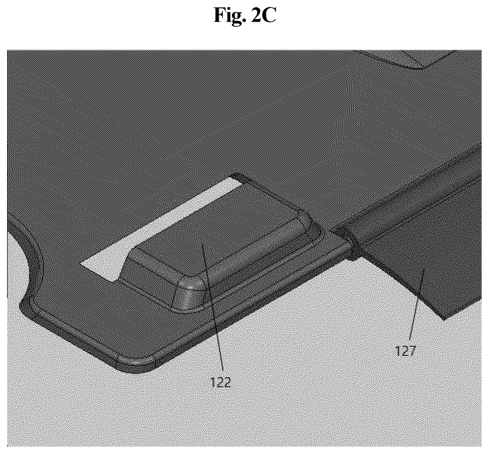

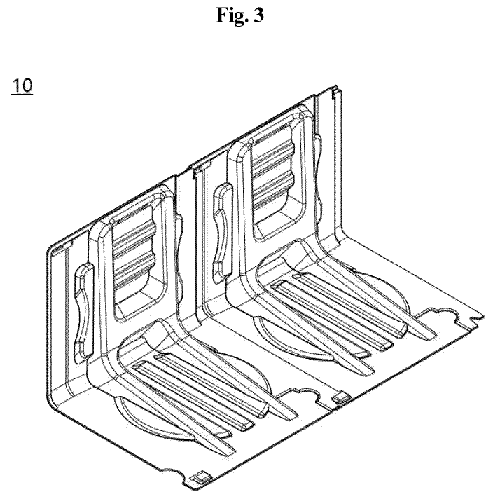

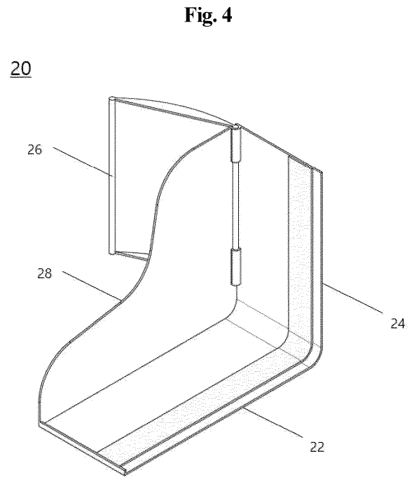

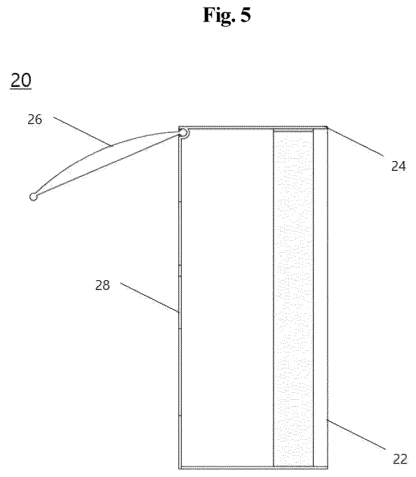

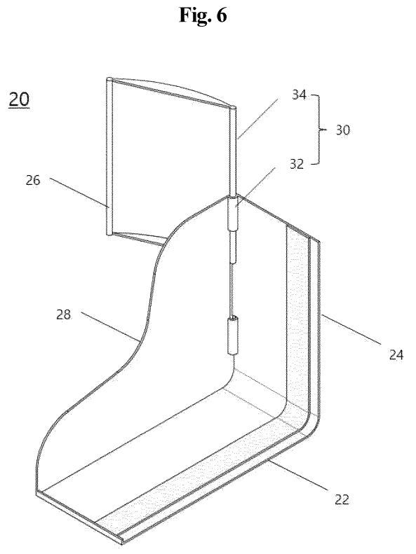

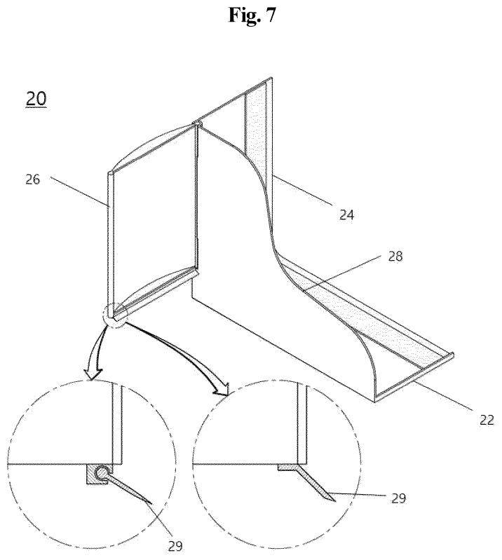

FIG. 1 illustrates a perspective view of waterproof plates for boundary stones and basic waterproof plates according to an embodiment of the present disclosure installed at the entrance of an underground parking lot. FIG. 2A illustrates a perspective view of a basic waterproof plate according to the present disclosure. FIGS. 2B and 2C illustrate a perspective view and an enlarged view of a gap blocking plate provided at a front end of the basic waterproof plate according to the present disclosure. FIG. 3 illustrates a perspective view of basic waterproof plates according to the present disclosure that are connected to each other and installed. FIG. 4 illustrates a perspective view of a waterproof plate for a boundary stone according to the present disclosure. FIG. 5 illustrates a plan view of the waterproof plate for the boundary stone according to the present disclosure. FIG. 6 illustrates a perspective view of a boundary blocking plate of the waterproof plate for the boundary stone according to the present disclosure that is coupled to a boundary wall plate. FIG. 7 illustrates a perspective view and an enlarged sectional view of a lower blocking plate installed by coupling to a lower end of the boundary blocking plate according to the present disclosure.

A waterproof plate 20 for the boundary stone according to an embodiment of the present disclosure is connected to and installed at a left or right end of a waterproof wall body that is formed by connecting a plurality of basic waterproof plates 10, each of which includes a bottom plate 12 that is placed on a ground surface 40 and a wall plate 14 that extends upward from a rear end of the bottom plate 12. The waterproof plate 20 includes: a boundary bottom plate 22 that is placed on the ground surface 40 and is connected to the bottom plate 12 of the basic waterproof plate 10; a boundary wall plate 24 that extends upward from a rear end of the boundary bottom plate 22 and is connected to the wall plate 14 of the basic waterproof plate 10; and a boundary blocking plate 26 that is coupled to the boundary wall plate 24 and is placed on a boundary ground surface 50 that is formed at a side end of the ground surface 40 to be stepped higher upward than the ground surface 40. The waterproof plate 20 may completely block the entry of water despite the boundary ground surface 50 being formed to be highly stepped upward at the side end of the ground surface 40.

The basic waterproof plate 10 includes the bottom plate 12 and the wall plate 14, and a plurality of basic waterproof plates 10 may be installed to be continuously connected to each other horizontally to form a waterproof wall body.

The waterproof wall body may block water from entering into areas behind the wall body. The waterproof wall body may be installed at the entrances of underground parking lots, underground roads, underground shopping malls, underground buildings, and the like and used to prevent flooding by blocking the entry of water into an underground space behind the wall body.

The bottom plate 12 of the basic waterproof plate 10 is installed on the ground surface 40 of an entrance into an underground space, and may be formed in a plate shape such as square, rectangular, or trapezoidal. The trapezoidal shape may be adopted when installing the waterproof wall body in an arc shape convex forward or rearward.

The wall plate 14 extends upward from the bottom plate 12, and may extend vertically upward or may extend inclinedly forward. The vertically upward shape or forward inclined shape may prevent the basic waterproof plate 10 from falling rearward. The wall plate 14 may be formed in a plate shape such as square or rectangular.

A joint portion between the wall plate 14 and the bottom plate 12 may be bent in a right angle shape or a gently curved shape.

The basic waterproof plates 10 may be installed in a manner of overlapping with each other, being coupled to each other with rings or strings, or being inserted into each other.

Referring to FIGS. 2A to 3, the basic waterproof plate 10 may have an insertion hole formed at a first side thereof and an insertion protrusion formed at a second side thereof so that neighboring basic waterproof plates 10 are coupled to each other by insertion of the insertion protrusion into the insertion hole. For example, a lower insertion hole 122 may be formed at a front end of a first side of the bottom plate 12, an upper insertion hole 142 may be formed at an upper end of a first side of the wall plate 14, a lower insertion protrusion 123 may be formed at a front end of a second side of the bottom plate 12, and an upper insertion protrusion 143 may be formed at an upper end of a second side of the wall plate 14, so neighboring basic waterproof plates 10 may be coupled to each other by insertion of each insertion protrusion into a corresponding insertion hole. The lower insertion hole 122 and the upper insertion hole 142 may be formed to be wide in the left-right direction. The wide lower insertion hole 122 and the upper insertion hole 142 may allow the degree of overlap between the basic waterproof plates 10 to be adjusted, thereby allowing the width of the waterproof wall body to be easily adjusted.

The basic waterproof plate 10 includes a pair of bottom protrusions 124 that protrude upward from the bottom plate 12 and have a height that gradually increases rearward, and a pair of parallel wall protrusions 144 that protrude forward from the wall plate 14. The wall protrusions 144 may be connected to the bottom protrusions 124.

The bottom protrusions 124 may extend from at a position spaced a predetermined distance rearward from a front end of the bottom plate 12 so that the height, the width, and the like thereof gradually increase rearward. When the bottom plate 12 is square, the pair of bottom protrusions 124 may be formed in a parallel shape. When the bottom plate 12 is trapezoidal, the pair of bottom protrusions 124 may be formed in a trapezoidal shape with a wide front portion or a wide rear portion.

The pair of wall protrusions 144 are preferably formed in a parallel shape with a lower portion connected to the bottom protrusions 124. The pair of wall protrusions 144 may be bent and extended in a right angle shape from the pair of bottom protrusions 124, or may be extended in a gently curved shape.

The basic waterproof plate 10 may further include an upper protrusion 145 that protrudes forward from the wall plate 14 and connects upper ends of the pair of wall protrusions 144 in the left-right direction, and a handle hole 146 that is formed therethrough below the upper protrusion 145.

The handle hole 146 may be very conveniently used for moving and installing the basic waterproof plates 10. After using the basic waterproof plates 10, they may be stacked and stored in an overlapping state by tying them with strings or wires through respective handle holes 146. Additionally, the basic waterproof plates 10 may be easily moved using tied strings or wires.

The basic waterproof plate 10 may further include a lower protrusion 147 that protrudes forward from the wall plate 14 and connects lower portions of the pair of wall protrusions 144 in the left-right direction.

The basic waterproof plate 10 may further include an auxiliary bottom protrusion 125 that protrudes upward between the pair of bottom protrusions 124. The auxiliary bottom protrusion 125 may extend from at a position spaced a predetermined distance rearward from the bottom plate 12 so that the height, the width, and the like thereof gradually increase rearward. One or more auxiliary bottom protrusions 125 may be formed.

Additionally, the basic waterproof plate 10 may further include an auxiliary wall protrusion 148 that is formed between the upper protrusion 145 and the lower protrusion 147 and connects the pair of wall protrusions 144 to each other. The auxiliary wall protrusion 148 may have a smaller protruding height than the upper protrusion 145 and the lower protrusion 147.

Additionally, the basic waterproof plate 10 may further include a pair of reinforcing protrusions 149 that protrude in a dumbbell shape from the pair of wall protrusions 144, respectively.

The basic waterproof plate 10 may further include a close-fitting member such as rubber, silicone, plastic, non-woven fabric, or woven fabric that is attached in a strip shape to a portion overlapping with a neighboring basic waterproof plate 10, a portion overlapping with the waterproof plate 20 for the boundary stone, or a portion in contact with the ground surface 40. The close-fitting member may eliminate a gap between neighboring basic waterproof plates 10, between the basic waterproof plate 10 and the waterproof plate 20 for the boundary stone, or between the basic waterproof plate 10 and the ground surface 40, thereby blocking water leakage, preventing slipping, and ensuring reliable coupling.

The bottom protrusions 124, the wall protrusions 144, the upper protrusion 145, the lower protrusion 147, and the auxiliary bottom protrusion 125 may greatly increase the rigidity of the basic waterproof plate 10, thereby enabling the basic waterproof plate 10 to effectively withstand water pressure even with a small amount of material.

The basic waterproof plate 10 may further include a gap blocking plate 127 that is coupled to the front end of the bottom plate 12. The gap blocking plate 127 may block a gap that is generated between the front end of the bottom plate 12 and the ground surface 40 due to inclination of the ground surface 40. That is, when the ground surface 40 is inclined in a curved shape, the front end of the bottom plate 12 is lifted. In this case, the gap blocking plate 127 may prevent water from flowing downward by blocking the gap. The gap blocking plate 127 may be coupled to the front end of the bottom plate 12 in a rotatable or downward tiltable manner, thereby effectively blocking the gap. Additionally, the gap blocking plate 127 may be coupled to the front end of the bottom plate 12 in a detachable or permanently attached manner.

Referring to FIGS. 4 to 7, the waterproof plate 20 for the boundary stone may further include an angle height adjustment part 30 that couples the boundary blocking plate 26 and the boundary wall plate 24 to each other. The angle height adjustment part 30 may include an arc-shaped groove 32 that is formed at an end of the boundary wall plate 24 and a spherical protrusion 34 that is formed at an end of the boundary blocking plate 26. The spherical protrusion 34 may be installed by sliding it into the arc-shaped groove 32 in the from-upper-to-lower direction. The protrusion 34 may be adjusted in vertical installation height thereof depending on the degree of insertion of the boundary blocking plate 26 and may be prevented from deviating in the lateral direction. The protrusion 34 may be rotatable within the groove 32 to effectively respond to changes in height and width of the boundary ground surface 50.

The arc-shaped groove 32 is formed to extend vertically at the end of the boundary wall plate 24, and may have an open side and an open top. The arc-shaped groove 32 may be formed entirely on upper and lower portions of the end of the boundary wall plate 24, or may be formed only on a part of the upper portion of the end of the boundary wall plate 24. When the groove 32 is formed only on the part of the upper portion, it is preferable to form it up to the minimum height of the boundary ground surface 50.

The spherical protrusion 34 may be formed entirely on upper and lower portions of a side end of the boundary blocking plate 26. The spherical protrusion 34 may be installed by sliding it into the arc-shaped groove 32 in the from-upper-to-lower direction and lowering it to the boundary ground surface 50. Additionally, the protrusion 34 may be appropriately rotated within the groove 32 and installed to fit the width of the boundary ground surface 50, thereby preventing a space through which water enters from occurring on a side of the boundary ground surface 50.

The waterproof plate 20 for the boundary stone may further include a boundary side plate 28 that connects an end of the boundary bottom plate 22 and an end of the boundary wall plate 24 to each other. The boundary side plate 28 may be formed in a shape with a front upper portion being cut and removed so that water flowing toward an outside and an inside of the boundary side plate 28 flows effectively to the left and right, thereby quickly eliminating the difference in water pressure. The boundary side plate 28 may increase the structural rigidity of the waterproof plate 20 for the boundary stone by coupling the boundary bottom plate 22 and the boundary wall plate 24 to each other.

A part of a central portion of the arc-shaped groove 32 may be open between the boundary side plate 28 and the boundary wall plate 24. The open part between the boundary side plate 28 and the boundary wall plate 24 may enable easy mold manufacturing and savings in manufacturing costs.

The boundary blocking plate 26 may be formed in an arc shape and may have flanges at upper and lower ends thereof. The arc shape and the flanges at the upper and lower ends may increase the rigidity of the boundary blocking plate 26, thereby making it possible to effectively respond to large water pressure.

Referring to FIG. 7, the waterproof plate 20 for the boundary stone may further include a lower blocking plate 29 that is coupled to the lower end of the boundary blocking plate 26. The lower blocking plate 29 may be installed inclinedly forward and downward. The lower blocking plate 29 may be made of a flexible material. The flexible lower blocking plate 29 may completely block the entry of water even when the boundary ground surface 50 is inclined in the front-rear direction or the left-right direction. Examples of the flexible material may include rubber, silicone, flexible plastic, and the like. Additionally, the boundary blocking plate 26 may be made of an inflexible material such as steel or plastic.

The lower blocking plate 29 may be integrally coupled to the lower end of the boundary blocking plate 26 with an adhesive, or may be detachably attached to the lower end of the boundary blocking plate 26 in a fitting manner. In the fitting manner, the lower blocking plate 29 may be coupled to the boundary blocking plate 26 by fitting engagement between an arc-shaped concave portion formed at any one of the lower end of the boundary blocking plate 26 and the upper end of the lower blocking plate 29 and a spherical convex portion formed at the remaining one thereof. Additionally, in the fitting manner, the lower blocking plate 29 may be removed and stored when not needed.

The waterproof plate 20 for the boundary stone and the basic waterproof plate 10 may be installed in a manner of overlapping with each other, being coupled to each other with rings or strings, or being inserted into each other.

As for the insertion coupling therebetween, the insertion coupling between the basic waterproof plates 10 illustrated in FIGS. 2A to 3 may be applied. For example, any one of the basic waterproof plate 10 and the waterproof plate 20 for the boundary stone may have an insertion hole and the remaining one thereof may have an insertion protrusion so that the basic waterproof plate 10 and the waterproof plate 20 for the boundary stone are coupled to each other by insertion of the insertion protrusion into the insertion hole. That is, the insertion coupling between the waterproof plate 20 for the boundary stone and the basic waterproof plate 10 may be achieved in the same manner as that between the basic waterproof plates 10 described above.

The waterproof plate 20 for the boundary stone may further include a close-fitting member such as rubber, silicone, plastic, non-woven fabric, or woven fabric that is attached in a strip shape to a portion overlapping with a neighboring basic waterproof plate 10 or a portion in contact with the ground surface 40. The close-fitting member may eliminate a gap between the waterproof plate 20 for the boundary stone and the basic waterproof plate 10 or between the waterproof plate 20 for the boundary stone and the ground surface 40, thereby blocking water leakage, preventing slipping, and ensuring reliable coupling.

The manner of installing the waterproof plate 20 for the boundary stone and the basic waterproof plate 10 by simply overlapping them may make it possible to effectively respond to the size of the installation width of the waterproof plate 20 for the boundary stone provided at the end of the waterproof wall body.

In the above description, although a description has been made such that all elements constituting embodiments of the present disclosure are combined into a single element or are operated with the elements being combined with each other, the present disclosure is not limited to those embodiments. That is, within the scope of the present disclosure, one or more of all elements may be selectively combined and operated. Unless the context clearly indicates otherwise, it should be further understood that terms “comprise”, “include”, or “have”, when used herein, specify the presence of corresponding elements, but do not preclude the presence or addition of one or more other elements. Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

The above description is merely intended to exemplarily describe the technical spirit of the present disclosure, and those skilled in the art will appreciate that various changes and modifications are possible without departing from the essential features of the present disclosure. Therefore, the embodiments of the present disclosure have not been described for limiting purposes, and the scope of the disclosure is not to be limited by the above embodiments. The protection scope of the present disclosure should be determined on the basis of the descriptions in the appended claims, and all equivalents thereof should belong to the scope of the present disclosure.

What is claimed is:

1. A waterproof plate for a boundary stone, the waterproof plate being connected to and installed at a left or right end of a waterproof wall body that is formed by connecting a plurality of basic waterproof plates, each of which comprises a bottom plate that is placed on a ground surface and a wall plate that extends upward from a rear end of the bottom plate, and the waterproof plate comprising:
a boundary bottom plate that is placed on the ground surface and is connected to the bottom plate of the basic waterproof plate;
a boundary wall plate that extends upward from a rear end of the boundary bottom plate and is connected to the wall plate of the basic waterproof plate; and
a boundary blocking plate that is coupled to the boundary wall plate and is placed on a boundary ground surface that is formed at a side end of the ground surface to be stepped higher upward than the ground surface,
wherein the waterproof plate completely blocks the entry of water despite the boundary ground surface being formed to be highly stepped upward at the side end of the ground surface.

2. The waterproof plate of claim 1, wherein the basic waterproof plate comprises:
a pair of bottom protrusions that protrude upward from the bottom plate and have a height that gradually increases rearward; and
a pair of parallel wall protrusions that protrude forward from the wall plate,
wherein the wall protrusions are connected to the bottom protrusions.

3. The waterproof plate of claim 2, wherein the basic waterproof plate further comprises:
an upper protrusion that protrudes forward from the wall plate and connects upper ends of the pair of wall protrusions in a left-right direction; and
a handle hole that is formed therethrough below the upper protrusion.

4. The waterproof plate of claim 2, wherein the basic waterproof plate further comprises a lower protrusion that protrudes forward from the wall plate and connects lower portions of the pair of wall protrusions in a left-right direction.

5. The waterproof plate of claim 1, wherein the basic waterproof plate further comprises a gap blocking plate that is coupled to a front end of the bottom plate,
wherein the gap blocking plate blocks a gap that is generated between the front end of the bottom plate and the ground surface due to inclination of the ground surface.

6. The waterproof plate of claim 1, further comprising:
an angle height adjustment part that couples the boundary blocking plate and the boundary wall plate to each other,
wherein the angle height adjustment part comprises: an arc-shaped groove that is formed at an end of the boundary wall plate; and a spherical protrusion that is formed at an end of the boundary blocking plate,
wherein the spherical protrusion is installed by sliding the spherical protrusion into the arc-shaped groove in a from-upper-to-lower direction, the protrusion is adjusted in vertical installation height thereof depending on a degree of insertion of the boundary blocking plate and is prevented from deviating in a lateral direction, and the protrusion is rotatable within the groove to effectively respond to changes in height and width of the boundary ground surface.

7. The waterproof plate of claim 6, further comprising:
a boundary side plate that connects an end of the boundary bottom plate and an end of the boundary wall plate to each other,
wherein the boundary side plate is formed in a shape with a front upper portion being cut and removed so that water flowing toward an outside and an inside of the boundary side plate flows effectively, thereby quickly eliminating a difference in water pressure.

8. The waterproof plate of claim 7, wherein a part of a central portion of the arc-shaped groove is open between the boundary side plate and the boundary wall plate.

9. The waterproof plate of claim 6, further comprising:
a lower blocking plate that is coupled to a lower end of the boundary blocking plate,
wherein the lower blocking plate is installed inclinedly forward and downward.

10. The waterproof plate of claim 9, wherein the lower blocking plate is integrally coupled to the lower end of the boundary blocking plate with an adhesive, or is detachably attached to the lower end of the boundary blocking plate in a fitting manner.
